(19) United States
(12) Patent Application Publication
(10) Pub. No.: US 2006/0081293 A1
(43) Pub. Date: Apr. 20, 2006

(54) Control valve for backwash prevention

(76) Inventors: Cathy D. Santa Cruz, Reno, NV (US); Anthony R. Cocucci, Reno, NV (US)

Correspondence Address: Cathy D. Santa Cruz, 7630 Tholl Drive, Reno, NV, 89506, US

(21) Appl. No.: 10/968,637

(22) Filed: Oct. 18, 2004

(51) Int. Cl. F16K 15/04

(52) U.S. Cl. 137/533.11

(57) ABSTRACT

Herein disclosed is a control valve that eliminates backpressure from contaminating the main pressurized substance that is flowing into the valve. The valve is of very simplified construction including no moving parts, is maintenance free, easy to install, and very cost effective. The valve is in the form of a housing having inlet/outlet ports and the housing having only a ball bearing and a ball diverter therein. The valve may include identification means such as a serial number for tracking, thus reducing the likelihood of intentional tampering. Also, the valve may include a window for viewing the contents there through.

### FIELD OF THE INVENTION

This invention relates in general to valves used for control of fluid flowing through a typical service water line but more particularly pertains to a one-way check valve that eliminates the possibility that a residential user might be able to contaminate the main water supply line via backflow or back pressure means.

### BACKGROUND

### Description of Prior Art

Backflow preventers are devices that are designed to allow a working fluid or fluid to pass through in the desired direction of fluid flow; they are designed to prevent backflow: fluid flow in an undesired or reverse direction. Two conditions that tend to drive fluid flow in the reverse direction include backpressure and back-siphonage. Backpressure is the condition by which fluid pressure increases downstream of the device. Back-siphonage is the condition that occurs when the fluid's supply pressure drops. For example, back-siphonage may occur when a water main breaks; there is a large draw on a water main such as when fire fighters are pumping water to extinguish a fire; a fluid pump falls in a building; a water closet is flushed; etc. Flow in a reverse direction is often not desired since it may involve contamination of the fluid's source with foreign elements or contaminants.

There are a wide variety of devices that deal with preventing backflow from occurring. A simple device called a check valve is often used to prevent backflow. Such a device often includes a moveable member made of rubber, metal, or other material which seats against a fixed member when a backflow-causing condition occurs. Ideally this seal prevents backflow. A variety of check valves exist. For example, U.S. Pat. No. 4,706,705 to Lee (1987) is a spring-loaded version. Other versions include U.S. Pat. No. 4,071,045 to Brandt (1978). U.S. Pat. No. 3,376,884 to Bucknell and Ward (1968) is an example of a check valve/fluid flow diverter combination. Fluid flow regulation devices or valves include, for example, U.S. Pat. No. 4,395,018 to Moen (1983). Practically, however, a backflow preventers seating member(s) often deteriorates or otherwise becomes fouled or functionally impaired with normal usage. Thus, if functionally impaired, a check valve will not prevent backflow from occurring. Furthermore, whether or not the check valve is functionally able to prevent backflow often remains unknown.

To offer additional protection against backflow, two check valves in tandem, called a double check valve, are often used. However, double check valves are of little more value than lone or single check valves; if operating conditions cause one check valve to become functionally impaired, they will likely have the same effect on the second check valve.

A third type of backflow preventer is the reduced pressure zone assembly. Reduced pressure zone backflow preventers often consist of a pressure differential relief valve located between two check valves. Reduced pressure zone backflow preventers are complicated devices that can only be functionally tested using a separate test kit, and a complex test procedure. Generally, a certified expert in testing backflow preventers is required to perform a detailed functionality test on the reduced pressure zone backflow preventer.

Vacuum breakers, or vents to the atmosphere, attempt to prevent backflow by opening a passage or vent to the atmosphere under the backflow-causing condition of back-siphonage. When back-siphonage occurs, a vacuum breaker often attempts to allow atmospheric pressure air to be drawn into the working fluid's supply line, rather than drawing fluid or contaminant. However, the air-ports of such devices can often become clogged, causing restriction. This leads to a deterioration of their intended abilities leaving little, if any, residual benefit. In addition, the working parts of a vacuum breaker often deteriorate with normal use and the device can become functionally impaired or otherwise fouled. Accordingly, such a device will not accomplish its desired function of preventing backflow.

Some backflow preventers may be comprised of combinations of the above described devices. A dual check valve assembly with an integral vacuum breaker is one such example. However, this redundancy accomplishes little additional protection against backflow in light of their individual flaws. None of the methods of dealing with backflow prevention described offers a viable solution to the problem of backflow prevention.

One problem that backflow preventers attempt to deal with is that if backflow occurs, contamination of the fluid's source may result. In the case of the public drinking water supply, contamination with chemicals has in fact led to mass illness, and even death. Instances can be cited where back-siphonage has let to ingestion of lethal chemicals by unknowingly drinking from a contaminated drinking water supply. This example merely highlights the need for, and seriousness, of adequate backflow protection.

### SUMMARY OF THE INVENTION

It is therefore a primary object of the present invention to provide a control valve for backwash prevention that is of simple construction, is easy to install, does not require any maintenance, is cost effective, and eliminates accidental or intentional contamination of the pressurized substance flowing through the valve.

Another object of the present invention is to provide a control valve for backwash prevention that is formed from only a housing having a ball bearing and a ball diverter therein and no other parts are required.

Yet another object of the present invention is to provide a control valve for backwash prevention that may be easily installed within any existing pressurized line in either a vertical or horizontal position depending on the requirements and limitations of the installation site. Furthermore, the valve may be installed at any location of choice, anywhere between the initial main source outlet and the receiving pipe to which it is connected.

A further object of the present invention is to provide a control valve that may be used for any type of pressurized substance, including fluid or air, etc.

Still another object of the present invention is to provide a control valve for backwash prevention that may be made from any suitable material of engineering choice. For example, the valve may be made from plastic and formed by a plastic mold injection, such as might be used with PVC pipes or the like. The valve may be integrally formed as one unit or formed from interconnecting parts. Or any other materials of choice such as aluminum, steel, cast iron (for galvanized pipes) or even hard rubber, Neoprene™, ceramics, etc.

Yet another object of the present invention is to provide a control valve for backwash prevention that may be transparent so as to allow an inspector or the like to easily view the contents flowing through the valve. Or if preferred, a viewing window may be incorporated as well.

A very important object of the present invention is to provide a control valve for backwash prevention that once installed, is fixedly attached in place and secured with some type of locking mechanism or includes a tamper-resistant identification protective sticker. Thereafter, if tampered with one can visually determine that tampering therewith is evident and an investigation is warranted.

It is another object of the present invention to provide a control valve for backwash prevention that eliminates the disadvantages and drawbacks associated with the known prior art. For example, the present invention eliminates any need for springs, rubber seals, air control valves, pressure relief valves, etc., and there are no moving parts that may break although the ball bearing moves within the housing.

Another important object of the present invention is to provide a control valve for backwash prevention wherein the ball bearing is made from a non-ferrous or non-metallic material. This is an extremely important safety feature of the present invention. The reason being is that if one were to try and disable the valve by use of a magnet this is no longer an option. Such disabling is a real inherent disadvantage associated within all of the current valves available and has heretofore not been addressed or resolved in the manner as taught herein.

Other objects and advantages will be seen when taken into consideration with the following drawings and specifications.

### BRIEF DESCRIPTION OF THE DRAWINGS

FIG. 1 is substantially a plan view of the present control valve when installed in a vertical position.

FIG. 2 is substantially a top overview for the construction of a ball diverter.

FIG. 3 is substantially an overview for the protective sticker.

FIG. 4 is substantially a plan view of the present control valve when installed in a horizontal position.

### DETAILED DESCRIPTION OF THE DRAWINGS

Referring now in detail to the drawings wherein like characters refer to like elements throughout the various views. The present invention is a control valve that is represented by overview (10) and which is to be interconnected to a main outlet such as input pipe (12), typically as associated with a water main for supplying water to a residence or the like. The main purpose of the valve (10) is to eliminate accidental or intentional backpressure initiated from the residence that may contaminate the main supply system. This is extremely important as this backpressure or backwash can totally pollute the incoming substance and in fact be life threatening.

The present invention control valve (10) is extremely simple in design substantially comprising of a housing (14), a ball diverter (16) and a ball bearing (18). Housing (14) having an inlet port (20) and an outlet port (22) that are spaced apart by an enlarged internal compartment (24) and housing (14) defining a vertical “Y” axis and a horizontal “X” axis. Inlet port (20) is connected by a first attachment means (later described) onto input pipe (12) thus inlet port (20) and input pipe (12) are in open communication with each other. Whereby, input pipe (12) delivers a pressurized substance (not shown) into inlet port (20).

As further depicted herein, outlet port (22) is connected by a second attachment means (later described) onto outlet pipe (26) thus outlet port (22) and outlet pipe (26) are in open communication with each other. Whereby, pressurized substance (not shown) is expelled outwardly from outlet port (22) and delivered into outlet pipe (26) for use by the end user, such as a residence or the like.

Referring now in particular to the internal construction of valve (10) wherein as can be seen enlarged internal compartment (24) has ball diverter (16) fixedly attached therein by any suitable attachment means such as by welding or the like. As can be further seen, ball diverter (16) when installed is to be aligned along the X-axis. The actual ball diverter (16) will be more fully described later herein.

It is to be noted ball bearing (18) has an outside circumference that is larger than an inside circumference of the inlet port (20) this is very important for function. As depicted herein, ball diverter (16) and outlet port (22) define a ball circulation area (28) there between. The ball circulation area (28) has the ball bearing (18) positioned therein and this circulation area allows ball bearing (18) to freely move therein and about in a non-restricted manner.

Therefore, during operation, the pressurized substance is forced into the ball circulation area (28) of housing (14) via inlet port (20), the pressurized substance is then force ably directed around ball bearing (18), around and throughout ball diverter (16), and then directed outwardly from within housing (14) via outlet port (22) and expelled into outlet pipe (26). Thus it can be seen, the pressurized substance is allowed to freely flow into and throughout valve (10) in an unobstructed manner and flow is not reduced or restricted.

However, in the event that backpressure is incurred via outlet pipe (26), the back pressure forces the pressurized substance back into housing (14) via outlet port (22), around and throughout ball diverter (16), into ball circulation area (28) and then forces ball bearing (18) into a position which blocks the pressurized substance from exiting housing (14) into inlet port (20) into inlet pipe (12). Thus, any possible contamination resulting from backpressure is now eliminated in a safe efficient simplified manner.

It is to be understood that it is extremely important that the ball bearing be made from a non-magnetic or non-ferrous material. This prevents a person from trying to cause a malfunction of the valve and eliminates successful tampering therewith. For example, within many types of valves, the ball bearing is made from a magnetic material, and if a person were to hold or simply position a magnet on the outside of the valve, the ball bearing would be magnetically attracted thereto and thus hold the bearing in a position that would cause malfunction and allow for backpressure to contaminate the main substance supply.

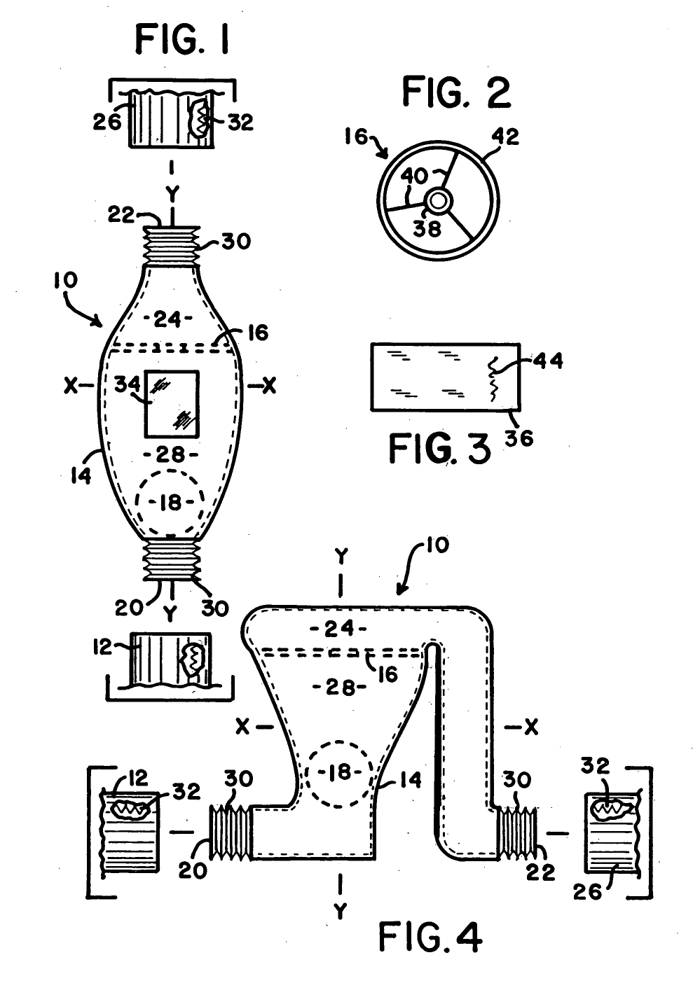

As previously noted, the first attachment means for connecting inlet port (20) onto input pipe (12) will now be addressed. As illustrated herein, first attachment means includes inlet port (20) having external threads (30) and input pipe (12) having internal threads (32) (only shown in FIG. 1 for clarity purposes) and external threads (30) and internal threads (32) are of a shape and size to have a threaded mating relationship. Whereby, inlet port (20) and input pipe (12) are removably yet securely affixed together.

As previously noted, the second attachment means for connecting outlet port (22) onto outlet pipe (26) will now be addressed. As illustrated herein, second attachment means includes outlet port (22) having external threads (30) and outlet pipe (26) having internal threads (32) (only shown in FIG. 1 for clarity purposes) and external threads (30) and internal threads (32) are of a shape and size to have a threaded mating relationship. Whereby, outlet port (22) and outlet pipe (26) are removably yet securely affixed together.

However, it is to be noted there are numerous types of suitable first and second attachment means therefore that as described herein is only exemplary of one possible type. Thus, the invention is not to be limited thereto and is to include other types of attachment means of engineering choice, such as soldering, gluing, brackets, friction fit, etc.

As previously addressed, we will now describe the preferred embodiment for the ball diverter (16) as depicted in FIG. 2. Wherein, the ball diverter is substantially in form of a donut (38) having at least two or more outwardly extending legs (40) each of which have a first end and a second end. The first end of each leg (40) being fixedly attached onto the donut (38) and the second end of each leg being fixedly attached onto a circular ring member (42). The circular ring member (42) not only functions to support the donut (38) in a secure manner but further serves as an attachment means for affixing the ball diverter (16) onto housing (14). It is to be understood that the attachment means for affixing ball diverter (16) onto housing (14) may be of any suitable attachment means of engineering choice, such as by welding, soldering, gluing, etc. It can now be seen due to the construction of the ball diverter (16) the pressurized substance can freely flow there about and throughout without restricting flow there through. However, ball diverter (16) will not allow ball bearing (16) to enter or block passage of the pressurized substance via outlet pipe (26) and thus functions as a ball-check valve respectively.

It is to be also understood that the housing (14) may be made from any suitable materials of engineering choice as well, and thus the invention is not to be limited thereto. For example housing (14) may be made from aluminum, steel, iron, hard rubber, neoprene, plastic, etc. However, it may be preferred to make the housing (14) from a transparent material. This would be feasible if made from plastic such as might be used with PVC pipes. This would also be advantageous as this further provides an aesthetically pleasing valve and also allows an inspector to easily visually view the contents contained or flowing through the valve.

Yet another aesthetically pleasing aspect is to include if so desired a display window (34) for viewing the pressurized substance there through. This allows an inspector or the like to visually determine the clarity of the substance within the valve.

Still another advantageous option is after the valve has been installed and each first and second attachment means have been secured, a protective sticker (26) is then applied to each attachment means thereon and or completely there about. Whereby, if control valve (10) is moved, disengaged or removed, the protective sticker (26) will be deformed and visually inform an inspector that the control valve has evidently been tampered with. However, in some circumstances it may be important to secure the valve in place with a locking mechanism. For example, when the valve is installed in high-risk areas such as within a prison facility this would be very advantageous. Therefore, although not depicted, the valve may be sold with attachment brackets having a locking means such as a pad lock or the like.

For additional convenience and safety the protective sticker may further include identification means represented by indicia (44) thereon, such as in the form of a serial number or the like. Whereby, each of the valves when sold or installed can be easily tracked and regulated. Still further if so desired the protective sticker may be color-coded so as to visually signify the date of installation. For example, each year those valves produced and sold may have a different colored sticker so as to signify the time of production and/or installation.

Yet another option for the protective sticker may be to make the sticker (26) from a heat-shrink material. This would be most advantageous as this not only provides a protective seal, but also enhances the effectiveness of the sticker, as this would further reveal tampering with the valve if incurred.

Still further it is to be noted that the present control valve (10) may be installed either in a vertical position as depicted in FIG. 1, or it may be installed horizontally as depicted in FIG. 4. However, although not shown, the housing as depicted in FIG. 1 may also be easily installed in a horizontal manner if required. For example, a first elbow shaped attachment pipe for connecting to the main, and a second elbow shaped attachment pipe for connection onto the outlet pipe. Thus the only modification for horizontal installation of the valve depicted in FIG. 1 is to include two elbow pipes.

Thus, the only difference between FIG. 1 and FIG. 4 is the shape of housing (14) but function, efficiency and the overall novel end results are exactly the same.

It is to be understood that the present control valve may be used for control of any type of pressurized substance, including fluid or air, etc. Thus, the invention is not to be limited to any specific substance, as the uses for such a valve are much too numerous to list.

It can now be seen we have herein provided and taught a new improved control valve that is versatile, is a retrofit respectively, may be vertically or horizontally easily installed and is cost effective to produce, market and sell.

Furthermore, the valve is of simplified construction having substantially no moving parts, is completely self-contained, may be made from numerous materials of choice, may be used for fluid, air, etc., and includes safety features that signify the valve has been tampered with, or the valve may be locked in a permanent position.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described the invention, what we claim as new and desire to secure by Letters Patent is:

1. A control valve for backwash prevention comprising: a housing: a ball diverter: and a ball bearing: said housing defining a Y axis and an X axis, said housing having an inlet port and an outlet port that are spaced apart by an enlarged internal compartment, said inlet port being connected by a first attachment means onto an input pipe, said inlet port and said input pipe being in open communication with each other whereby said input pipe delivers a pressurized substance into said inlet port, said outlet port being connected by a second attachment means onto an outlet pipe, said outlet port and said outlet pipe being in open communication with each other whereby said pressurized substance is expelled outwardly from said outlet port and delivered into said outlet pipe, said enlarged internal compartment having said ball diverter fixedly attached therein, said ball bearing having an outside circumference that is larger than an inside circumference of said inlet port, said ball diverter being aligned along said X-axis, said ball diverter and said outlet port defining a ball circulation area there between, said ball circulation area having said ball bearing positioned therein and said ball circulation area allowing said ball bearing to freely move therein and about in a non-restricted manner,
whereby:
during operation, said pressurized substance is forced into said ball circulation area of said housing via said inlet port, said pressurized substance is then force-ably directed around said ball bearing, around said ball diverter and then directed outwardly from within said housing via said outlet port into said outlet pipe, however, if backpressure is incurred via said outlet pipe, said back pressure forces said pressurized substance back into said housing via said outlet port, around said ball diverter, into said ball circulation area and then forces said ball bearing into a position which blocks said pressurized substance from exiting into said inlet port into said inlet pipe.

2. The control valve of claim 1 wherein said ball bearing is made from a non-ferrous material.

3. The control valve of claim 1 wherein said ball bearing is made from a non-metallic material.

4. The control valve of claim 1 wherein said first attachment means comprising: said inlet port having external threads, said input pipe having internal threads and said external threads and said internal threads having a removable threaded mating relationship.

5. The control valve of claim 1 wherein said first attachment means comprising: a solder weld between said input pipe and said inlet port.

6. The control valve of claim 1 wherein said second attachment means comprising:
said outlet port having external threads, said outlet pipe having internal threads and said external threads and said internal threads having a removable threaded mating relationship.

7. The control valve of claim 1 wherein said second attachment means comprising: a solder weld between said outlet port and said outlet pipe.

8. The control valve of claim 1 wherein said housing is made from a transparent material.

9. The control valve of claim 1 wherein said housing further includes a display window for viewing said pressurized substance there through.

10. The control valve of claim 1 wherein each said attachment means after being secured in place, further includes a protective sticker applied in an affixed manner thereon or completely there about,
whereby:
if said control valve is moved, disengaged or removed, said protective sticker will be deformed and visually inform an inspector that said control valve has evidently been tampered with.

11. The control valve of claim 10 wherein said protective sticker further includes identification means.

12. The control valve of claim 11 wherein said identification means is in the form of a serial number.

13. The control valve of claim 10 wherein said protective sticker is made from a heat shrink material.

14. The control valve of claim 10 wherein said protective sticker is color-coded so as to signify visually the date of installation.

15. The control valve of claim 1 wherein said pressurized substance is either fluid or air.
